(19) United States
(12) Patent Application Publication
(10) Pub. No.: US 2019/0308569 A1
(43) Pub. Date: Oct. 10, 2019

(54) ONBOARD DEVICE

(71) Applicants: AutoNetworks Technologies, Ltd., Yokkaichi-shi , Mie (JP); Sumitomo Wiring Systems, Ltd., Yokkaichi-shi , Mie (JP); Sumitomo Electric Industries, Ltd., Osaka-shi (JP)

(72) Inventors: Kentaro Ashibe, Yokkaichi-shi, Mie (JP); Masakatsu Moriguchi, Yokkaichi-shi, Mie (JP)

(21) Appl. No.: 16/339,758

(22) PCT Filed: Oct. 2, 2017
(86) PCT No.: PCT/JP2017/035793

§ 371 Date: Apr. 5, 2019

(30) Foreign Application Priority Data
Oct. 7, 2016 (JP) 2016-199112

(51) Int. Cl. B60R 16/023; H02J 7/04; H02J 1/00; H04L 12/46; H02J 7/00; B60L 15/00; H02M 3/156; H02J 7/34

(52) U.S. Cl. CPC B60R 16/023; H02J 7/04; H02J 1/00; H02J 7/345; H02J 7/0063; B60L 15/007; H02M 3/156; H04L 12/46

(57) ABSTRACT

An onboard device has an electricity storage, a control unit, a first communication circuit, and a memory. Power stored in the electricity storage is supplied to the control unit, the first communication circuit, and the memory. A main switch is provided on a power supply path extending from the electricity storage to the first communication circuit and the memory. When the terminal voltage of the electricity storage falls below a threshold value, the main switch is switched off.

### CROSS-REFERENCE TO RELATED APPLICATIONS

This application is the U.S. national stage of PCT/JP2017/035793 filed Oct. 2, 2017, which claims priority of Japanese Patent Application No. JP 2016-199112 filed Oct. 7, 2016, the contents of which are incorporated herein.

### TECHNICAL FIELD

The present disclosure relates to an onboard device provided with an electricity storage and a plurality of constituent elements to which power is supplied from the electricity storage.

### BACKGROUND

Onboard devices, such as ECUs (electronic control units), are each equipped with a plurality of constituent elements that include a microcomputer. An onboard device is connected to the positive electrode of a battery, and power is supplied from the battery to the constituent elements.

The onboard device is further equipped with an electricity storage. The electricity storage includes a capacitor, for example, and is charged from the battery. If power supply from the battery to the onboard device temporarily stops, power is supplied from the electricity storage to the constituent elements. Therefore, even if power supply from the battery to the onboard device temporarily stops, the microcomputer continuously executes processing.

JP 2014-192994A discloses a power supply apparatus in which power is supplied from a power source to a plurality of loads. Switches are respectively provided on a plurality of power supply paths extending from the power source to the respective loads. These switches are turned on or off depending on the magnitude of a current that flows in the respective power supply paths.

In recent years, as functions of onboard devices keep improving, the number of constituent elements that are mounted in each of the onboard devices has been increasing. If the number of constituent elements to which an electricity storage supplies power is large, there is a problem that a period during which power supply from the electricity storage to a microcomputer can be maintained is short.

Examples of configurations for solving this problem include a configuration in which an electricity storage with a large capacity is mounted in an onboard device. For example, by increasing the number of capacitors that are connected in parallel, or using a capacitor with a large capacity, an electricity storage with a large capacity is realized. If an electricity storage with a large capacity is used, the size of the electricity storage is large, and thus the size of the onboard device is also large. The space inside the vehicle is limited, and thus it is not desirable that the size of the onboard device is large.

The present disclosure has been made in light of the above issue, and aims to provide a small onboard device that can supply power from an electricity storage to a specific target for a long time.

### SUMMARY

An onboard device according to the present disclosure that is provided with an electricity storage and first and second targets to which power stored in the electricity storage is supplied includes a switch that is provided on a power supply path extending from the electricity storage to the second target, and that is switched off when a terminal voltage of the electricity storage falls below a threshold value.

In the present disclosure, initially, power is supplied from the electricity storage to the first target and the second target. When the terminal voltage of the electricity storage falls below the threshold value, the switch is turned off, and power supply from the electricity storage to the second target stops. Accordingly, power that is released by the electricity storage per unit time falls. As a result, power is supplied from the electricity storage to the first target for a long time. In addition, along with a fall of the terminal voltage of the electricity storage, the number of targets to which the electricity storage supplies power decreases, and thus it is possible to use a small electricity storage with a small capacity. In this case, the size of the device is small.

In the onboard device according to the present disclosure, the switch is switched on when the terminal voltage of the electricity storage rises to at least the threshold value.

In the present disclosure, when the terminal voltage of the electricity storage rises and reaches the threshold value, the switch is switched on, and power is supplied to the second target again.

In the onboard device according to the present disclosure, the number of second targets is at least two, switches are provided respectively on a plurality of power supply paths extending from the electricity storage to the respective second targets, and a threshold value of a switch provided on one power supply path is different from at least one of the threshold values of the switches provided on the other power supply paths.

In the present disclosure, power is supplied from the electricity storage to a plurality of second targets, and there are a plurality of power supply paths. Switches are respectively provided on the power supply paths. The threshold value of the switch provided on one power supply path is different from at least one of the threshold values of the switches provided on the other power supply paths. Therefore, along with fall of the terminal voltage of the electricity storage, the number of second targets in which power supply is stopped increases stepwise. As a result, it is possible to continue power supply from the electricity storage to the first target for a long time while suppressing degradation of the function of the device.

In the onboard device according to the present disclosure, the first target is a control unit that controls an operation of the onboard device, and the second target is an electrical device that operates in accordance with an instruction of the first target.

In the present disclosure, the electricity storage stops power supply to the electrical device that operates in accordance with an instruction of the control unit that controls operations of the device nvsuch as a microcomputer, and thereby power is supplied to the control unit for a long time.

### Advantageous Effects of Disclosure

According to the present disclosure, it is possible to realize a small onboard device that can supply power to from an electricity storage to a specific target for a long time.

### BRIEF DESCRIPTION OF DRAWINGS

FIG. 1 is a block diagram showing a main configuration of a power source system in a first embodiment.

FIG. 2 is a circuit diagram of a supply control circuit.

FIG. 3 is an explanatory diagram of power supply when a main switch is not provided.

FIG. 4 is an explanatory diagram of power supply in an onboard device.

FIG. 5 is a block diagram showing a main configuration of a power source system in a second embodiment.

FIG. 6 is an explanatory diagram of power supply in an onboard device.

FIG. 7 is a block diagram showing a main configuration of a power source system in a third embodiment.

### DETAILED DESCRIPTION OF PREFERRED EMBODIMENTS

The present disclosure will be described in detail below with reference to the drawings illustrating embodiments of the disclosure.

### First Embodiment

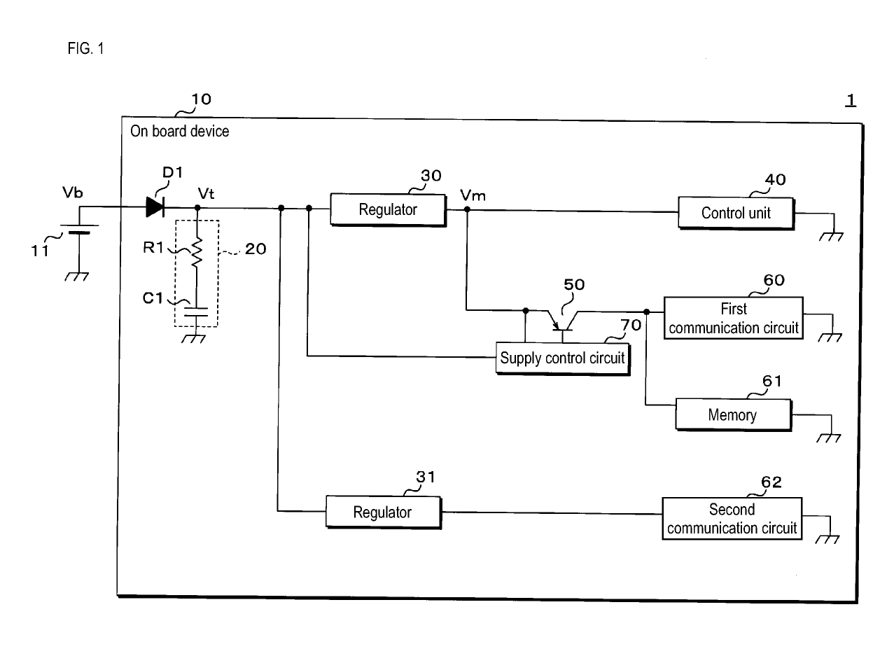

FIG. 1 is a block diagram showing a main configuration of a power source system 1 in a first embodiment. The power source system 1 is provided with an onboard device 10 and a battery 11. The positive electrode of the battery 11 is connected to the onboard device 10. The negative electrode of the battery 11 is grounded.

Power is supplied from the battery 11 to the onboard device 10. The onboard device 10 stores power supplied from the battery 11. The onboard device 10 operates using power supplied from the battery 11 or stored power. The onboard device 10 is an ECU, for example.

The onboard device 10 has an electricity storage 20, regulators 30 and 31, a control unit 40, a main switch 50, a first communication circuit 60, a memory 61, a second communication circuit 62, a supply control circuit 70, and a diode D1. The electricity storage 20 has a capacitor C1 and a resistor R1. The capacitor C1 is the main portion of the electricity storage 20, and the resistor R1 is the internal resistance of the electricity storage 20. The main switch 50 is a PNP-type bipolar transistor.

The anode of the diode D1 is connected to the positive electrode of the battery 11. The cathode of the diode D1 is connected to one end of the resistor R1 of the electricity storage 20 and one end of each of the regulators 30 and 31. In the electricity storage 20, the other end of the resistor R1 is connected to one end of the capacitor C1, and the other end of the capacitor C1 is grounded.

The other end of the regulator 30 is connected to the control unit 40 and the emitter of the main switch 50. The collector of the main switch 50 is connected to the first communication circuit 60 and the memory 61. The supply control circuit 70 is connected to the cathode of the diode D1, and the emitter and base of the main switch 50. The other end of the regulator 31 is connected to the second communication circuit 62. The control unit 40, the first communication circuit 60, the memory 61, and the second communication circuit 62 are grounded.

The battery 11 outputs a battery voltage Vb via the diode D1. Accordingly, the voltage is applied between the two ends of the electricity storage 20. At this time, in the electricity storage 20, power is supplied to the capacitor C1 via the resistor R1, and the capacitor C1 is charged. Since the diode D1 is provided, no current flows from the electricity storage 20 to the battery 11, and the electricity storage 20 does not charge the battery 11.

If the voltage at the base of the main switch 50 with respect to the potential of the emitter is lower than a negative constant voltage, a current can flow between the emitter and the collector. At this time, the main switch 50 is on. If the voltage at the base of the main switch 50 with respect to the potential of the emitter is larger than or equal to the above negative constant voltage, no current flows between the emitter and the collector. At this time, the main switch 50 is off.

The supply control circuit 70 switches on or off the main switch 50 by adjusting the voltage of base with respect to potential of emitter, in the main switch 50.

If a terminal voltage Vt of the electricity storage 20 at one end of the resistor R1 is higher than or equal to a predetermined first reference voltage Vr, the regulator 30 transforms the terminal voltage Vt into a predetermined first target voltage Vg, and outputs the first target voltage Vg. The first reference voltage Vr is higher than the first target voltage Vg. If the terminal voltage Vt is lower than the first reference voltage Vr, the regulator 30 outputs a voltage that is lower than the first target voltage Vg. If the terminal voltage Vt is lower than the first reference voltage Vr, then the voltage that is output by the regulator 30 decreases together with the terminal voltage Vt.

Regardless of whether or not the main switch 50 is on, the voltage output by the regulator 30 is applied to the control unit 40. Accordingly, power is supplied to the control unit 40, and the control unit 40 operates using the supplied power.

When the main switch 50 is on, the voltage output by the regulator 30 is further applied to the first communication circuit 60 and the memory 61. Accordingly, power is also supplied to the first communication circuit 60 and the memory 61, which operate using the supplied power.

When the main switch 50 is off, no power is supplied from the regulator 30 to the first communication circuit 60 and the memory 61, and the first communication circuit 60 and the memory 61 stop operating.

If the terminal voltage Vt is larger than or equal to a predetermined second reference voltage, the regulator 31 transforms the terminal voltage Vt into a predetermined second target voltage, and outputs the second target voltage. The second reference voltage is higher than the second target voltage. When the terminal voltage Vt is lower than the second reference voltage, the regulator 31 outputs a voltage that is lower than the second target voltage. If the terminal voltage Vt is lower than the second reference voltage, a voltage that is output by the regulator 31 decreases together with the terminal voltage Vt. The second target voltage is different from the first target voltage.

The voltage output by the regulator 31 is applied to the second communication circuit 62. Accordingly, power is supplied to the second communication circuit 62, and the second communication circuit 62 operates using the supplied power.

The range of voltage drop across the diode D1 when a current flows from the anode to the cathode is hereinafter referred to as “forward voltage”. If the battery voltage Vb is higher than or equal to a voltage obtained by adding the forward voltage to the terminal voltage Vt of the electricity storage 20, a current flows from the battery 11 to the regulators 30 and 31, and power of the battery 11 is consumed. If the battery voltage Vb is lower than the voltage obtained by adding the forward voltage to the terminal voltage Vt, then a current flows from the electricity storage 20 to the regulators 30 and 31, and the power stored in the electricity storage 20 is consumed.

Therefore, if the battery voltage Vb is lower than the voltage obtained by adding the forward voltage to the terminal voltage Vt, the electricity storage 20 supplies the power stored therein to the control unit 40 via the regulator 30. If the battery voltage Vb is lower than the voltage obtained by adding the forward voltage to the terminal voltage Vt, and the main switch 50 is on, the electricity storage 20 supplies the power stored therein to the first communication circuit 60 and the memory 61 via the regulator 30 and the main switch 50. This indicates that the main switch 50 is provided on a power supply path extending from the electricity storage 20 to the first communication circuit 60 and the memory 61. The control unit 40 functions as a first target, and one of the first communication circuit 60 and the memory 61 functions as a second target.

A main voltage Vm that is applied to the control unit 40 is substantially the same as the voltage that is output by the regulator 30. Therefore, when the regulator 30 is outputting the first target voltage Vg, the main voltage Vm is substantially the same as the first target voltage Vg. If the main voltage Vm is lower than the first target voltage Vg, the control unit 40 stops operating.

Communication lines (not illustrated) are respectively connected to the first communication circuit 60 and the second communication circuit 62. The first communication circuit 60 and the second communication circuit 62 receive data transmitted via the respective communication lines connected thereto. Furthermore, the first communication circuit 60 and the second communication circuit 62 transmit data via the respective communication lines connected thereto in accordance with instructions of the control unit 40. The control unit 40 reads out data from the memory 61, and stores the data to the memory 61.

The control unit 40 is a microcomputer, for example, and controls operations of the onboard device 10. The control unit 40 controls operations of the onboard device 10 as follows, for example. The control unit 40 stores data received by the first communication circuit 60, to the memory 61, and instructs the second communication circuit 62 to transmit data stored in the memory 61. Furthermore, the control unit 40 stores data received by the second communication circuit 62, to the memory 61, and instructs the first communication circuit 60 to transmit the data stored in the memory 61. As described above, the control unit 40 relays communication that is performed between the apparatus connected to one communication line and the apparatus connected to the other communication line.

The first communication circuit 60, the memory 61 and the second communication circuit 62 are electrical devices that operate as follows, in accordance with instructions of the control unit 40.

When the terminal voltage Vt of the electricity storage 20 falls below a threshold value V0, the supply control circuit 70 switches off the main switch 50. Accordingly, power supply to the first communication circuit 60 and the memory 61 stops. When the terminal voltage Vt rises to the threshold value V0 or higher, the supply control circuit 70 switches on the main switch 50. Accordingly, power supply to the first communication circuit 60 and the memory 61 is resumed.

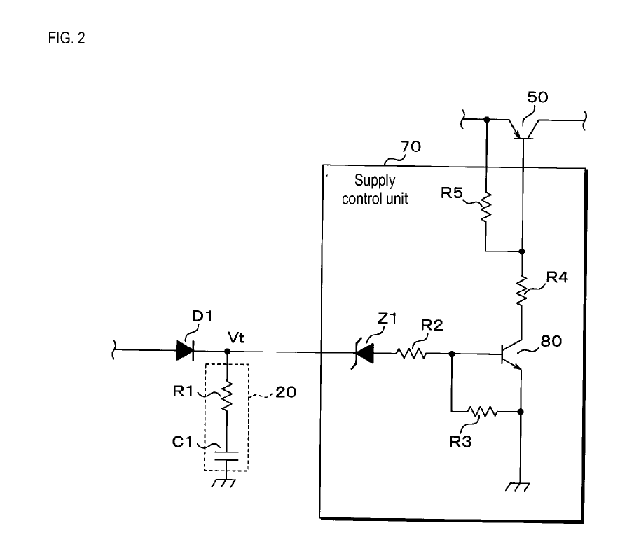

FIG. 2 is a circuit diagram of the supply control circuit 70. The supply control circuit 70 includes a sub switch 80, resistors R2, R3, R4, and R5, and a zener diode Z1. The sub switch 80 is an NPN-type bipolar transistor.

The cathode of the zener diode Z1 is connected to one end of the resistor R1 of the electricity storage 20. The anode of the zener diode Z1 is connected to one end of the resistor R2. The other end of the resistor R2 is connected to the base of the sub switch 80 and one end of the resistor R3. The emitter of the sub switch 80 and the other end of the resistor R3 are grounded. The collector of the sub switch 80 is connected to one end of the resistor R4. The other end of the resistor R4 is connected to the base of the main switch 50 and one end of the resistor R5. The other end of the resistor R5 is connected to the emitter of the main switch 50.

If the voltage at the base of the sub switch 80 with respect to the potential of the emitter is higher than or equal to a positive constant voltage, a current can flow between the collector and emitter. At this time, the sub switch 80 is on. If the voltage at the base of the sub switch 80 with respect to the potential of the emitter is lower than the above positive constant voltage, no current flows between the collector and emitter. At this time, the sub switch 80 is off.

If the voltage at the cathode of the zener diode Z1 with respect to the potential of the anode is lower than a predetermined voltage, then no current flows through the zener diode Z1. If the voltage at the cathode of the zener diode Z1 with respect to the potential of the anode is higher than or equal to the predetermined voltage, a current flows through the zener diode Z1.

If the terminal voltage Vt of the electricity storage 20 is lower than the threshold value V0, then the voltage at the cathode of the zener diode Z1 with respect to the potential of the anode is lower than the predetermined voltage. In this case, no current flows through the resistors R2 and R3, and thus, the voltage at the base of the sub switch 80 with respect to the potential of the emitter is zero V, and is lower than the above positive constant voltage. Therefore, the sub switch 80 is off.

When the sub switch 80 is off, no current flows through the resistors R5 and R4, and thus, the voltage at the base of the main switch 50 with respect to the potential of the emitter is zero V, and is higher than or equal to the above negative constant voltage. Therefore, the main switch 50 is off. When the main switch 50 is off, power supply to the first communication circuit 60 and the memory 61 is shut off, as described above.

If the terminal voltage Vt of the electricity storage 20 is higher than or equal to the threshold value V0, the voltage at the cathode of the zener diode Z1 with respect to the potential of the anode is higher than or equal to the predetermined voltage. In this case, a current flows from the battery 11 or the electricity storage 20 to the zener diode Z1 and the resistors R2 and R3 in that order, and there is a voltage drop across the resistor R3. At this time, the voltage at the base of the sub switch 80 with respect to the potential of the emitter is higher than or equal to the above positive constant voltage, and the sub switch 80 is switched on.

When the sub switch 80 is on, a current flows from the other end of the regulator 30 through the resistors R5 and R4 and the sub switch 80 in that order, and there is a voltage drop at the resistor R5. At this time, the voltage at the base of the main switch 50 with respect to the potential of the emitter is lower than the above negative constant voltage, and the main switch 50 is switched on.

As described above, when the terminal voltage Vt of the electricity storage 20 falls below the threshold value V0, the sub switch 80 and the main switch 50 are sequentially switched off, and power supply to the first communication circuit 60 and the memory 61 stops. In addition, when the terminal voltage Vt of the electricity storage 20 rises to the threshold value V0 or higher, the sub switch 80 and the main switch 50 are sequentially switched on, and power supply to the first communication circuit 60 and the memory 61 is resumed.

The supply control circuit 70 is constituted by hardware, and thus, when the terminal voltage Vt of the electricity storage 20 falls below the threshold value V0, the main switch 50 is immediately switched off. Furthermore, when the terminal voltage Vt of the electricity storage 20 rises to the threshold value V0 or higher, the main switch 50 is immediately switched on.

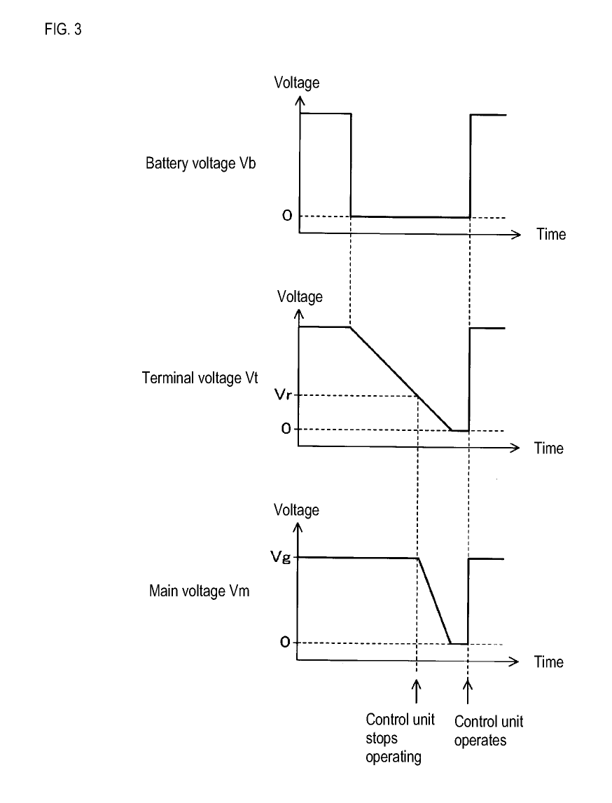

FIG. 3 shows diagrams illustrating the power supply when the main switch 50 is not provided. FIG. 3 shows graphs of the battery voltage Vb, and the terminal voltage Vt and the main voltage VmW of the electricity storage 20 over time. The horizontal axes of these graphs indicate time.

If the main switch 50 is not provided, in other words, if the other end of the regulator 30 is directly connected to the first communication circuit 60 and the memory 61, when the battery voltage Vb falls to a voltage that is lower than a voltage obtained by adding the forward voltage of the diode D1 to the terminal voltage Vt of the electricity storage 20, power supply from the electricity storage 20, specifically, the capacitor C1 to the control unit 40, the first communication circuit 60, the memory 61, and the second communication circuit 62 is started. An example will be described below in which the battery voltage Vb fell to zero V.

The power of the capacitor C1 is supplied, the voltage between the two ends of the capacitor C1 falls, and the terminal voltage Vt of the electricity storage 20 falls. While the terminal voltage Vt of the electricity storage 20 is higher than or equal to the first reference voltage Vr, the regulator 30 outputs the first target voltage Vg, and power is supplied to the control unit 40, the first communication circuit 60, and the memory 61. At this time, the main voltage Vm is substantially the same as the first target voltage Vg.

When the terminal voltage Vt of the electricity storage 20 falls below the first reference voltage Vr, the main voltage Vm falls below the first target voltage Vg, and the control unit 40 stops operating. While the terminal voltage Vt of the electricity storage 20 is lower than the first reference voltage Vr, the state of the control unit 40 is maintained in a suspended (stopped) state. When the battery voltage Vb rises, and the terminal voltage Vt of the electricity storage 20 rises to the first reference voltage Vr or higher, the regulator 30 outputs the first target voltage Vg, and the control unit 40 operates again, as described above.

If power supply to the control unit 40 stops, data stored in a RAM (random access memory, not illustrated) of the control unit 40 is unexpectedly deleted, for example. Accordingly, there is a risk that one or more processes to be executed by the control unit 40 are not appropriately executed. Therefore, it is necessary to avoid an unexpected stop of power supply to the control unit 40.

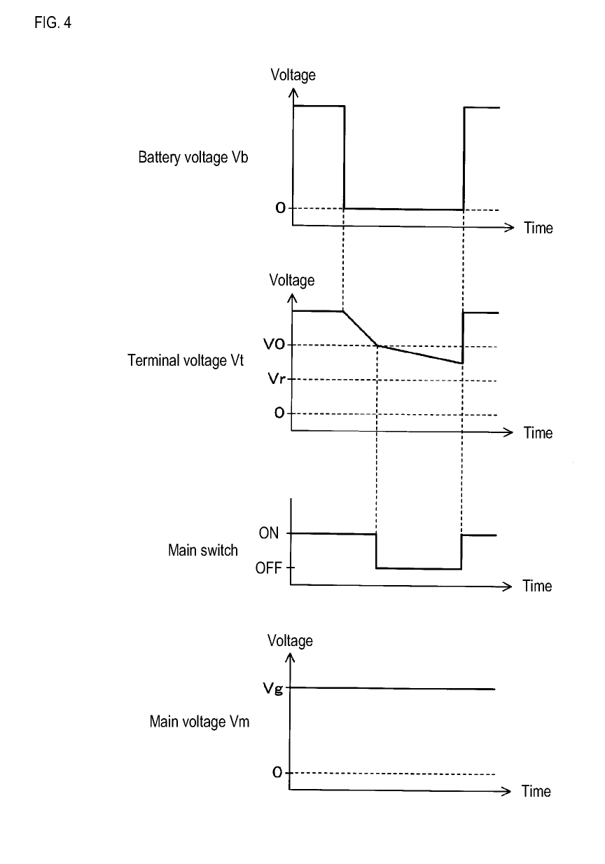

FIG. 4 shows diagrams illustrating the power supply in the onboard device 10. Similar to FIG. 3, FIG. 4 shows graphs of the battery voltage Vb, and the terminal voltage Vt and the main voltage Vm of the electricity storage 20 over time. FIG. 4 further shows how the main switch 50 transitions between on and off. The horizontal axes of the four graphs shown in FIG. 4 indicate time.

In the onboard device 10, if the battery voltage Vb is lower than a voltage obtained by adding the forward voltage of the diode D1 to the terminal voltage Vt of the electricity storage 20, power supply from the electricity storage 20, specifically, the capacitor C1 to the control unit 40, the first communication circuit 60, the memory 61, and the second communication circuit 62 is started. An example will be described below in which the battery voltage Vb fell to zero V.

The power of the capacitor C1 is supplied, the voltage between the two ends of the capacitor C1 falls, and the terminal voltage Vt of the electricity storage 20 falls. While the terminal voltage Vt is higher than or equal to the threshold value V0, the main switch 50 is on, and power is supplied from the regulator 30 to the control unit 40, the first communication circuit 60, and the memory 61.

When the terminal voltage Vt of the electricity storage 20 falls below the threshold value V0, the main switch 50 is switched from on to off. Accordingly, power supply from the electricity storage 20 to the first communication circuit 60 and the memory 61 is stopped. As a result, the power that is released by the electricity storage 20 per time unit falls, and the terminal voltage Vt of the electricity storage 20 decreases gradually. The threshold value V0 is higher than the first reference voltage Vr.

In addition, the terminal voltage Vt of the electricity storage 20 rises along with the rise of the battery voltage Vb.

In the onboard device 10, when the terminal voltage Vt of the electricity storage 20 falls below the threshold value V0, the main switch 50 is switched off, and power supply from the electricity storage 20 to the first communication circuit 60 and the memory 61 stops. Accordingly, the power that is released by the electricity storage 20 per time unit falls. As a result, the power is supplied from the electricity storage 20 to the control unit 40 for a longer time, and, during a period since when the battery voltage Vb falls to zero V until when the battery voltage Vb rises again, the terminal voltage Vt of the electricity storage 20 does not fall below the first reference voltage Vr. Therefore, the main voltage Vm is maintained at the first target voltage Vg, and the control unit 40 does not stop operating.

In addition, the number of targets to which the electricity storage 20 supplies power decreases as the terminal voltage Vt of the electricity storage 20 decreases, and thus a small electricity storage 20 with a smaller capacity can be used in the onboard device 10. In this case, the size of the onboard device 10 is small.

The supply control circuit 70 can be constituted by small components, and the size of the main switch 50 is small. Therefore, the main switch 50 and the supply control circuit 70 can be implemented on the opposite surface of the surface of the substrate on which the electricity storage 20 is implemented, for example. Therefore, the space occupied by the main switch 50 and the supply control circuit 70 is small.

Furthermore, while the terminal voltage Vt of the electricity storage 20 is higher than or equal to the threshold value V0, the first communication circuit 60 and the memory 61 are operating, and functions of the onboard device 10 are maintained.

As described above, the terminal voltage Vt of the electricity storage 20 rises along with rise of the battery voltage Vb. When the terminal voltage Vt of the electricity storage 20 rises to the threshold value V0 or higher, the main switch 50 is switched from off to on, and power is supplied to the first communication circuit 60 and the memory 61 again.

### Second Embodiment

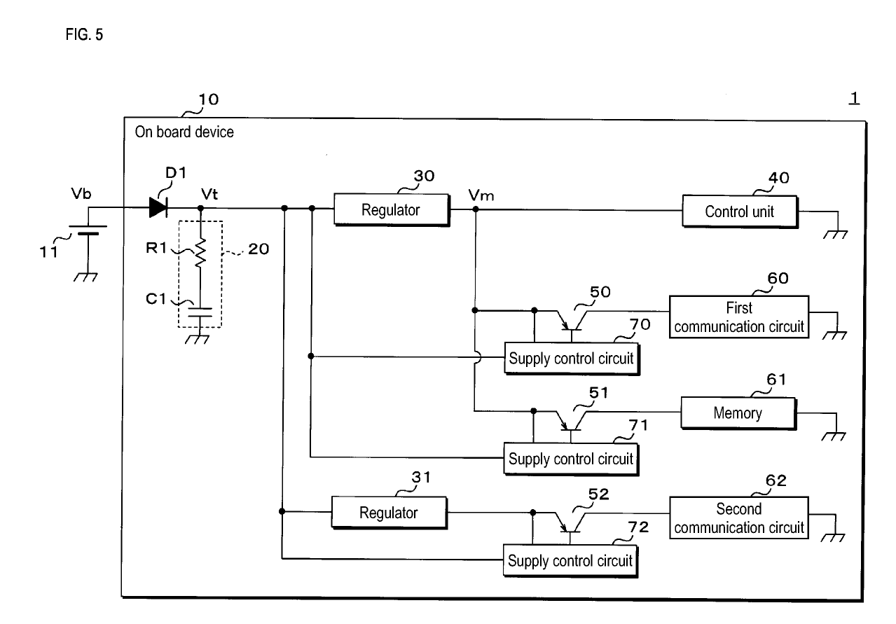

FIG. 5 is a block diagram showing a main configuration of a power source system 1 in a second embodiment.

Differences between the first embodiment and the second embodiment will be described below. Structures other than the structures described later are the same as in the first embodiment, and thus the same reference numerals as in the first embodiment are assigned to structures that are the same as in the first embodiment, and their description is omitted.

The configuration of an onboard device 10 in the power source system 1 in the second embodiment is different from the power source system 1 in the first embodiment. The onboard device 10 in the second embodiment includes main switches 51 and 52 and supply control circuits 71 and 72 in addition to the constituent elements of the onboard device 10 of the first embodiment. The main switches 51 and 52 are PNP-type bipolar transistors.

An electricity storage 20, regulators 30 and 31, a control unit 40, a main switch 50, a first communication circuit 60, a supply control circuit 70, and a diode D1 are connected similar in the same way as in the first embodiment. The anode of the diode D1 is connected to the positive electrode of a battery 11. Furthermore, the other end of the regulator 30 is connected to the emitter of the main switch 51. The collector of the main switch 51 is connected to the memory 61. The supply control circuit 71 is connected to the cathode of the diode D1 and the emitter and base of the main switch 51.

The other end of the regulator 31 is connected to the emitter of the main switch 52. The collector of the main switch 52 is connected to a second communication circuit 62. The supply control circuit 72 is connected to the cathode of the diode D1 and the emitter and base of the main switch 52. The control unit 40, the first communication circuit 60, the memory 61, and the second communication circuit 62 are grounded just like in the second embodiment.

The main switches 51 and 52 act similar to the main switch 50. Therefore, if the voltage of the base with respect to the potential of the emitter is higher than or equal to a negative constant voltage, the main switches 51 and 52 are on, and if the voltage of the base with respect to the potential of the emitter is lower than the negative constant voltage, they are off.

The configurations and actions of the supply control circuits 71 and 72 are respectively similar to the configuration and action of the supply control circuit 70. The configuration and action of the supply control circuit 71 can be described by respectively replacing the main switch 50, the supply control circuit 70, and the threshold value V0 with the main switch 51, the supply control circuit 71 and a threshold value V1, in the description on the configuration and action of the supply control circuit 70. The threshold value V1 is lower than the threshold value V0.

In addition, the configuration and action of the supply control circuit 72 can be described by respectively replacing the regulator 30, the main switch 50, the supply control circuit 70, and the threshold value V0 with the regulator 31, the main switch 52, the supply control circuit 72, and a threshold value V2, in the description on the configuration and action of the supply control circuit 70. The threshold value V2 is lower than the threshold value V1.

Thus, when a terminal voltage Vt of the electricity storage 20 falls below the threshold value V0, the supply control circuit 70 switches off the main switch 50. When the terminal voltage Vt falls below the threshold value V1 (<V0), the supply control circuit 71 switches off the main switch 51. When the terminal voltage Vt falls below the threshold value V2 (<V1), the supply control circuit 72 switches off the main switch 52.

In addition, when the terminal voltage Vt rises to the threshold value V2 or higher, the supply control circuit 72 switches on the main switch 52. When the terminal voltage Vt rises to the threshold value V1 (>V2) or higher, the supply control circuit 71 switches on the main switch 51. When the terminal voltage Vt rises to the threshold value V0 (>V1) or higher, the supply control circuit 70 switches on the main switch 50.

As described above, the threshold value V1 is lower than the threshold value V0, and the threshold value V2 is lower than the threshold value V1, and thus each of the threshold values V0, V1, and V2 is different from at least one of the other threshold values.

Regardless of whether or not the main switches 50, 51, and 52 are on, the voltage output by the regulator 30 is applied to the control unit 40. Accordingly, power is supplied to the control unit 40, and the control unit 40 operates using the supplied power.

When the main switch 50 is on, the voltage output by the regulator 30 is further applied to the first communication circuit 60. Accordingly, power is also supplied to the first communication circuit 60, and the first communication circuit 60 operates using the supplied power. When the main switch 50 is off, no power is supplied from the regulator 30 to the first communication circuit 60, and the first communication circuit 60 stops operating.

When the main switch 51 is on, the voltage output by the regulator 30 is further applied to the memory 61. Accordingly, power is also supplied to the memory 61, and the memory 61 operates using the supplied power. When the main switch 51 is off, no power is supplied from the regulator 30 to the memory 61, and the memory 61 stops operating.

When the main switch 52 is on, the voltage output by the regulator 31 is applied to the second communication circuit 62. Accordingly, power is supplied to the second communication circuit 62, and the second communication circuit 62 operates using the supplied power. When the main switch 52 is off, no power is supplied from the regulator 31 to the second communication circuit 62, and the second communication circuit 62 stops operating.

If a battery voltage Vb is lower than a voltage obtained by adding a forward voltage to the terminal voltage Vt, the electricity storage 20 supplies the power stored therein to the control unit 40 via the regulator 30.

If the battery voltage Vb is lower than the voltage obtained by adding the forward voltage to the terminal voltage Vt, and the main switch 50 is on, the electricity storage 20 supplies the power stored therein to the first communication circuit 60 via the regulator 30 and the main switch 50.

In a similar case, when the main switch 51 is on, the electricity storage 20 supplies the power stored therein to the memory 61 via the regulator 30 and the main switch 51.

In a similar case, when the main switch 52 is on, the electricity storage 20 supplies the power stored therein to the second communication circuit 62 via the regulator 31 and the main switch 52.

As a result, the following is found. The main switch 50 is provided on a power supply path extending from the electricity storage 20 to the first communication circuit 60. The main switch 51 is provided on a power supply path extending from the electricity storage 20 to the memory 61. The main switch 52 is provided on a power supply path extending from the electricity storage 20 to the second communication circuit 62. The control unit 40 functions as a first target, and the first communication circuit 60, the memory 61, and the second communication circuit 62 function as second targets. Therefore, the number of second targets is three.

Like in the supply control circuit 70, the supply control circuits 71 and 72 are also configured by hardware. Therefore, when the terminal voltage Vt of the electricity storage 20 falls below the threshold value V1, the main switch 51 is immediately switched off. When the terminal voltage Vt of the electricity storage 20 falls below the threshold value V2, the main switch 52 is immediately switched off. Furthermore, when the terminal voltage Vt of the electricity storage 20 rises to the threshold value V1 or higher, the main switch 51 is immediately switched on. When the terminal voltage Vt of the electricity storage 20 rises to the threshold value V2 or higher, the main switch 52 is immediately switched on.

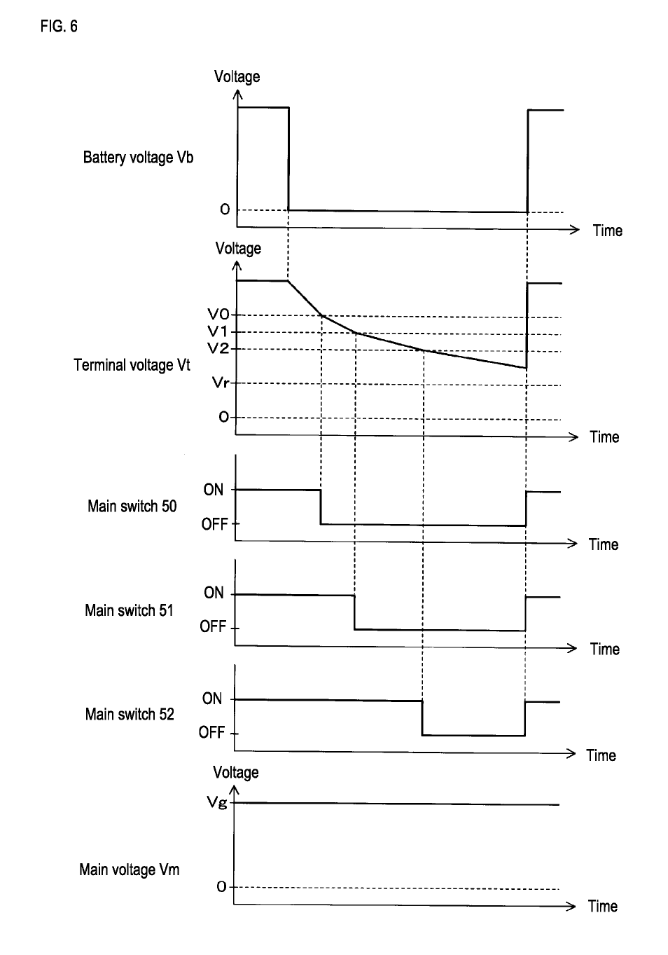

FIG. 6 is a diagram illustrating the power supply in the onboard device 10. FIG. 6 corresponds to FIG. 4. Like FIG. 4, FIG. 6 shows graphs of the battery voltage Vb, the terminal voltage Vt and a main voltage Vm of the electricity storage 20, and how the main switch 50 transitions between on and off. FIG. 6 further shows how the main switches 51 and 52 transition between on and off. The horizontal axes of these graphs indicate time.

In the onboard device 10, when the battery voltage Vb falls below a voltage that is lower than the terminal voltage Vt of the electricity storage 20, power supply from the electricity storage 20, specifically, the capacitor C1 to the control unit 40, the first communication circuit 60, the memory 61, and the second communication circuit 62 is started. An example will be described below in which the battery voltage Vb falls to zero V.

The power of the capacitor C1 is supplied, the voltage between the two ends of the capacitor C1 falls, and the terminal voltage Vt of the electricity storage 20 falls. While the terminal voltage Vt is higher than or equal to the threshold value V0, the main switches 50, 51, and 52 are on. At this time, power is supplied from the regulator 30 to the control unit 40, the first communication circuit 60, and the memory 61, and power is supplied from the regulator 31 to the second communication circuit 62.

When the terminal voltage Vt of the electricity storage 20 falls below the threshold value V0, the main switch 50 is switched from on to off. Accordingly, power supply from the electricity storage 20 to the first communication circuit 60 is stopped. As a result, power that is released by the electricity storage 20 per unit time falls, and the terminal voltage Vt of the electricity storage 20 falls gradually.

When the terminal voltage Vt falls below the threshold value V1, the main switch 51 is further switched from on to off. Accordingly, power supply from the electricity storage 20 to the memory 61 is stopped. As a result, power that is released by the electricity storage 20 per unit time further falls, and the terminal voltage Vt of the electricity storage 20 further falls gradually.

If the terminal voltage Vt falls below the threshold value V2, the main switch 52 is further switched from on to off. Accordingly, power supply from the electricity storage 20 to the second communication circuit 62 is stopped. As a result, power that is released by the electricity storage 20 per unit time further falls, and the terminal voltage Vt of the electricity storage 20 further falls gradually. The threshold value V2 is higher than the first reference voltage Vr.

In addition, the terminal voltage Vt of the electricity storage 20 rises along with rise of the battery voltage Vb

In the onboard device 10, along with fall of the terminal voltage Vt of the electricity storage 20, the main switches 50, 51, and 52 are sequentially switched off. Accordingly, the number of constituent elements, power supply to which stops, increases stepwise. Therefore, it is possible to continue power supply from the electricity storage 20 to the control unit 40 for a long time while suppressing degradation of functions of the onboard device 10.

In addition, a timing when power supply to the memory 61 stops is later than a timing when power supply to the first communication circuit 60 stops. Therefore, power supply to the memory 61 can be stopped after data received by the first communication circuit 60 is stored in the memory 61.

Similar to the supply control circuit 70, the supply control circuits 71 and 72 can be each constituted by small components, and, similar to the main switch 50, the sizes of the main switches 51 and 52 are small. Therefore, the main switches 50, 51, and 52 and the supply control circuits 70, 71, and 72 can be implemented on the opposite surface of the surface of the substrate on which the electricity storage 20 is implemented, for example. Therefore, the space occupied by the main switches 50, 51, and 52 and the supply control circuits 70, 71, and 72 is small.

During a period since when the battery voltage Vb falls to zero V until when the battery voltage Vb rises, the terminal voltage Vt of the electricity storage 20 does not fall below the first reference voltage Vr. Therefore, the main voltage Vm is maintained at the first target voltage Vg, and the control unit 40 does not stop operating.

When the terminal voltage Vt of the electricity storage 20 rises to the threshold value V2 or higher, the main switch 52 is switched from off to on, and power is supplied to the second communication circuit 62 again. When the terminal voltage Vt rises to the threshold value V1 or higher, the main switch 51 is switched from off to on, and power is supplied to the memory 61 again. When the terminal voltage Vt rises to the threshold value V0 or higher, the main switch 50 is switched from off to on, and power is supplied to the first communication circuit 60 again.

The onboard device 10 in the second embodiment has a configuration in which the main switches 51 and 52 and the supply control circuits 71 and 72 are added to the configuration of the onboard device 10 in the first embodiment. Therefore, the onboard device 10 in the second embodiment has an effect similar to that of the onboard device 10 in the first embodiment.

Note that, in the second embodiment, the number of second targets is not limited to three, and it suffices for the number of second targets to be two or more. In this case, for example, main switches are respectively provided on a plurality of power supply paths extending from the electricity storage 20 to the respective second targets.

In addition, the threshold value of the main switch provided on one power supply path does not need to be different from all of the threshold values of the main switches provided on the other power supply paths, and it suffices for the threshold value of the main switch provided on one power supply path to be different from at least one of the main switches provided on the other power supply paths. For example, a configuration may be adopted in which the threshold value V0 is the same as the threshold value V2, and the threshold value V1 is different from the threshold values V0 and V2.

### Third Embodiment

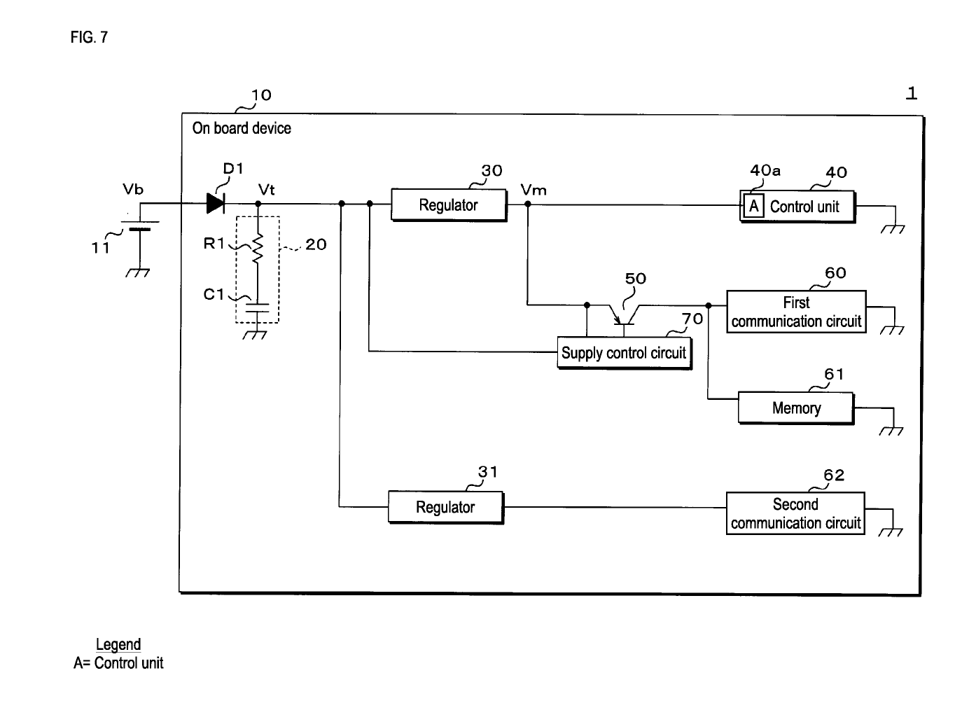

FIG. 7 is a block diagram showing a main configuration of a power source system 1 in a third embodiment.

Differences between the first embodiment and the third embodiment will be described below. Structures other than the structures described later are the same as in the first embodiment, and thus the same reference signs as in the first embodiment are assigned to structures that are the same as in the first embodiment, and their description is omitted.

The control unit 40 includes constituent elements such as a CPU (Central Processing Unit) and a non-volatile memory, in addition to the RAM described in the first embodiment. The control unit 40 further has a power supply circuit 40a. In the onboard device 10 in the third embodiment, the power supply circuit 40a is connected to the other end of a regulator 30. Power is supplied to the power supply circuit 40a via the regulator 30. In addition, in the control unit 40, the power supply circuit 40a supplies power supplied from the regulator 30, to the constituent elements other than the power supply circuit 40a.

In the control unit 40, the power supply circuit 40a stops power supply to the constituent elements other than the power supply circuit 40a, for example, in accordance with an instruction of the CPU. Accordingly, from among the constituent elements of the control unit 40, constituent elements other than the power supply circuit 40a stop operating, and the state of the control unit 40 transitions to a so-called sleep state. For example, a signal is input to the power supply circuit 40a from outside. If a specific signal is input from outside in a state where power supply to constituent elements other than the power supply circuit 40a is stopped, the power supply circuit 40a resumes the power supply to these constituent elements. Accordingly, the state of the control unit 40 transitions to a so-called wakeup state.

In the onboard device 10 in the third embodiment, if a battery voltage Vb is higher than or equal to a voltage obtained by adding a forward voltage to a terminal voltage Vt, the power of the battery 11 is supplied to the power supply circuit 40a of the control unit 40. In addition, if the battery voltage Vb is lower than the voltage obtained by adding the forward voltage to the terminal voltage Vt, power stored in the electricity storage 20 is supplied to the power supply circuit 40a of the control unit 40 via the regulator 30.

The onboard device 10 in the third embodiment configured as described above has a similar effect to the first embodiment. Furthermore, in the onboard device 10 in the third embodiment, the state of the control unit 40 transitions to a sleep state, and thus power is efficiently supplied to the control unit 40.

Note that the control unit 40 in the power source system 1 in the second embodiment may be configured similar to the third embodiment. In other words, a configuration may be adopted in which the control unit 40 in the second embodiment also includes the power supply circuit 40a, and power is supplied to the power supply circuit 40a via the regulator 30. The power source system 1 configured like this has an effect similar to that described in the second embodiment, and, in addition, power is efficiently supplied to the control unit 40.

Note that, in the first to third embodiments, the constituent element (target) to which power is always supplied is not limited to the control unit 40 that controls operations of the onboard device 10. In addition, the number of constituent elements to which power is always supplied is not limited to one, and may be two or more. For example, the control unit 40 and the memory 61 may be the constituent elements to which power is always supplied.

In addition, the main switch does not need to be a switch in which a threshold value that is used for a switch from on to off and a threshold value that is used for a switch from off to on are the same.

Furthermore, the configuration of the electricity storage 20 is not limited to a configuration in which the capacitor C1 is provided, and may be a configuration in which a battery is provided.

In addition, it is sufficient, if the regulators 30 and 31 function as transformation units that transform the terminal voltage Vt of the electricity storage 20. Therefore, in place of the regulators 30 and 31, a DCDC converter may be used, for example. Furthermore, the number of transformation units is not limited to two, and it suffices for the number of transformation units to be one or more. In the example in FIG. 1, the other end of the regulator 30 may be further connected to the second communication circuit 62. In this case, the onboard device 10 does not include the regulator 31.

In addition, if it is not necessary to transform the terminal voltage Vt of the electricity storage 20, one end of the electricity storage 20 may be connected to constituent elements such as the control unit 40, the first communication circuit 60, the memory 61, or the second communication circuit 62 without using a transformation unit such as regulator or a DCDC converter. For example, in the configurations shown in FIG. 1, 5, or 7, if the second communication circuit 62 is configured to operate as a result of applying a voltage that is higher than or equal to the second target voltage, one end of the electricity storage 20 may be connected to the second communication circuit 62 without using the regulator 31.

The main switch is not limited to a PNP-type bipolar transistor, and may also be a NPN-type bipolar transistor, an FET (field effect transistor), a relay contact, or the like. The sub switch 80 is not limited to an NPN-type bipolar transistor, and may also be a PNP-type bipolar transistor, an FET, a relay contact, or the like.

The disclosed first to third embodiments are to be considered as illustrative and non-limiting in all aspects. The scope of the present disclosure is indicated not by the above-stated meanings but by the scope of claims, and is intended to include all modifications that are within the meanings and the scope that are equivalent to those of the scope of claims.

1. An onboard device that is provided with an electricity storage and first and second targets to which power stored in the electricity storage is supplied, the onboard device comprising:
a switch that is provided on a power supply path extending from the electricity storage to the second target, that is switched off when a terminal voltage of the electricity storage falls below a threshold value, and that is off when a voltage at its control end with respect to a potential at its one end on the electricity storage side is higher than or equal to a negative constant voltage;
a resistor that is connected between the one end of the switch on the electricity storage side and the control end; and
a second switch whose one end is connected to the control end, and that is switched off when the terminal voltage falls below the threshold value.

2. The onboard device according to claim 1,
wherein the switch is switched on when the terminal voltage of the electricity storage rises to at least the threshold value.

3. The onboard device according to claim 1,
wherein the number of second targets is at least two,
switches are provided respectively on a plurality of power supply paths extending from the electricity storage to the respective second targets, and
a threshold value of a switch provided on one power supply path is different from at least one of the threshold values of the switches provided on the other power supply paths.

4. The onboard device according to claim 1,
wherein the first target is a control unit that controls an operation of the onboard device, and
the second target is an electrical device that operates in accordance with an instruction of the first target.

5. The onboard device according to claim 1,
wherein the second switch is off when a voltage at a second control end is lower than a constant voltage, and
a zener diode whose cathode is connected to the electricity storage, and whose anode is connected to the second control end is provided.

6. The onboard device according to claim 2,
wherein the number of second targets is at least two,
switches are provided respectively on a plurality of power supply paths extending from the electricity storage to the respective second targets, and
a threshold value of a switch provided on one power supply path is different from at least one of the threshold values of the switches provided on the other power supply paths.

7. The onboard device according to claim 2,
wherein the first target is a control unit that controls an operation of the onboard device, and
the second target is an electrical device that operates in accordance with an instruction of the first target.

8. The onboard device according to claim 3,
wherein the first target is a control unit that controls an operation of the onboard device, and
the second target is an electrical device that operates in accordance with an instruction of the first target.

9. The onboard device according to claim 2,
wherein the second switch is off when a voltage at a second control end is lower than a constant voltage, and
a zener diode whose cathode is connected to the electricity storage, and whose anode is connected to the second control end is provided.

10. The onboard device according to claim 3,
wherein the second switch is off when a voltage at a second control end is lower than a constant voltage, and
a zener diode whose cathode is connected to the electricity storage, and whose anode is connected to the second control end is provided.

11. The onboard device according to claim 4,
wherein the second switch is off when a voltage at a second control end is lower than a constant voltage, and
a zener diode whose cathode is connected to the electricity storage, and whose anode is connected to the second control end is provided.
